(19) United States
(12) Patent Application Publication
(10) Pub. No.: US 2018/0238290 A1
(43) Pub. Date: Aug. 23, 2018

(54) SYSTEM AND METHOD FOR ALTERING START-STOP EVENTS

(71) Applicant: Ford Global Technologies, LLC, Dearborn, MI (US)

(72) Inventors: Siraj SIDDIQUI, Lasalle (CA); Hafiz Shafeek KHAFAGY, Deaborn, MI (US); Ahmed AWADI, Farmington Hills, MI (US); Hussam MAKKIYA, Troy, MI (US)

(21) Appl. No.: 15/436,152

(22) Filed: Feb. 17, 2017

(51) Int. Cl. F02N 11/08; F02D 41/04; F02D 41/12; F02D 41/26

(52) U.S. Cl. CPC F02N 11/0822; F02D 41/042; F02D 2200/602; F02D 41/26; F02D 2200/101; F02D 41/12

(57) ABSTRACT

A vehicle is provided. The vehicle may include a controller that, in response to a number of engine stops that occur within a first predefined time period exceeding a user defined threshold value, inhibit further engine auto stops. The vehicle may include a controller that, in response to a number of engine stops that occur within a first predefined distance travelled by the vehicle exceeding a user defined threshold value, inhibit further engine auto stops.

### TECHNICAL FIELD

This disclosure relates to a rolling start-stop system that allows a driver to dictate the number of start-stop events.

### BACKGROUND

Fuel economy and emissions performance of an automobile is an important characteristic. A higher fuel economy and lower emissions rating may make a vehicle more attractive to potential buyers and may help an automotive manufacturer meet fuel economy and emissions standards imposed by local governments. For traditional gasoline or diesel vehicles, one method of reducing fuel consumption is the use of a micro-hybrid or start-stop powertrain system that selectively turns its engine off during portions of a drive cycle. As an example, a controller of a start-stop vehicle can turn the engine off while the vehicle is stopped rather than allow the engine to idle. And, the controller can then restart the engine when a driver steps on the accelerator pedal.

### SUMMARY

According to one embodiment of this disclosure, a vehicle is provided. The vehicle includes an engine and a controller configured to, in response to a number of auto stops that occur within a first predefined time period exceeding a user defined threshold value, inhibit further auto stops of the engine.

According to another embodiment of this disclosure, a vehicle including an engine, a controller, and a human-machine interface is provided. The controller may be configured to auto stop the engine in response to a speed of the engine being less than a threshold. The human-machine interface may be configured to prompt a user to provide feedback regarding whether further engine auto stops should be inhibited, and in response to the feedback being affirmative, to provide a signal to the controller to inhibit further auto stops.

According to yet another embodiment of this disclosure, an engine and a controller is provided. The controller is configured to, in response to a number of auto stops of the engine that occur within a first predefined distance travelled by the vehicle exceeding a user defined threshold value, inhibit further engine auto stops.

### BRIEF DESCRIPTION OF THE DRAWINGS

FIG. 1 is a schematic diagram of a vehicle having a start-stop control system.

FIG. 2 is a flow diagram illustrating a method of controlling a start-stop vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

An objective of the controller of a start-stop vehicle powertrain may include stopping an engine such as an internal combustion engine, (e.g., a gasoline engine or a diesel engine). The controller may be used to stop the engine by inhibiting an ignition coil of the engine or by inhibiting the injection of fuel into engine cylinders. The controller may stop the engine based on input from vehicle sensors. The signals from the sensors may be indicative of a speed of the vehicle, a force applied to a brake pedal (or absence thereof), a force applied to an accelerator pedal (or absence thereof), an angle of inclination of the vehicle, the weight of the vehicle, or other vehicle characteristics. One other important characteristic of the vehicle is a voltage level of a battery of the vehicle used to start the engine and power electrical automotive systems such as electric power steering (EPS), electric power brakes, electric stability control (ESC), and other vehicle control systems. Along with vehicle control systems are vehicle comfort systems such as seat heaters, an air conditioning system, and a window defroster. An extension of a traditional start-stop is a rolling start-stop system (RSS).

A traditional start-stop system may be configured to auto-stop the engine when the vehicle is not in motion (e.g., 0 mph), a force is applied to the brake pedal, and the voltage level for the vehicle battery is above a threshold. The threshold is selected based on the energy required to start the engine via an electric starter. Once the engine is stopped, the controller may automatically start the engine if the gear selector is in drive and there is an absence of force applied to the brake pedal. In other embodiments of a start-stop vehicle, the controller may be configured to auto-stop the engine when the vehicle is in motion at a speed below a low speed threshold (e.g., 2 mph or 4 mph), a force is applied to the brake pedal, and the voltage level for the vehicle battery is above a threshold. When the vehicle is in motion, the threshold is a higher threshold as the vehicle still requires some power to activate electric power brakes and EPS. Along with the traditional start-stop control system, a vehicle may be configured to start-stop the engine when the vehicle is in motion above a lower threshold. This system is also referred to as a rolling start-stop system (RSS).

An RSS may have additional benefits such as an improved fuel economy rating, improved vehicle emissions, and reducing engine noise. These benefits may be in addition to the improvements from a conventional start-stop system. An RSS allows the engine to auto-stop at a higher vehicle speed once a driver applies the brakes and the vehicle speed is less than an upper vehicle speed threshold.

Producing energy by the engine only when needed/required is one of the main approaches to maximizing fuel economy while minimizing emissions in vehicles equipped with internal combustion engines. Accordingly, RSS systems are being considered for implementation across a range of modern vehicles for all of the world's key markets. A RSS system may include a battery system that may be implemented a single battery, dual batteries, any number of batteries. The battery system may have an operating voltage approximately equal to a standard vehicle battery (i.e., 12 Volts) or may operate at other voltages (e.g., 24V, 48V, etc.) RSS systems may utilize any combination of same or different technologies of batteries or power sources such as Lead Acid, Enhanced Flooded (EFB), Absorbent Glass Mat (AGM), LI-Ion or any other battery technology.

One of the challenges with implementing RSS technology in vehicles is preventing too many start stop events within a specific time window when the vehicle is operating under certain conditions. Because stop events occur in response to the velocity of the vehicle below a threshold and/or the pressure of the brake pedal is above a threshold, the vehicle may stop at an inopportune time, e.g. in a drive-thru line at a fast food restaurant, a security check point, a toll booth, and etc. Successive stopping events within a relatively short period of time or distance may annoy the driver or other drivers in line behind the driver and who have to wait for the engine to restart as the line moves forward.

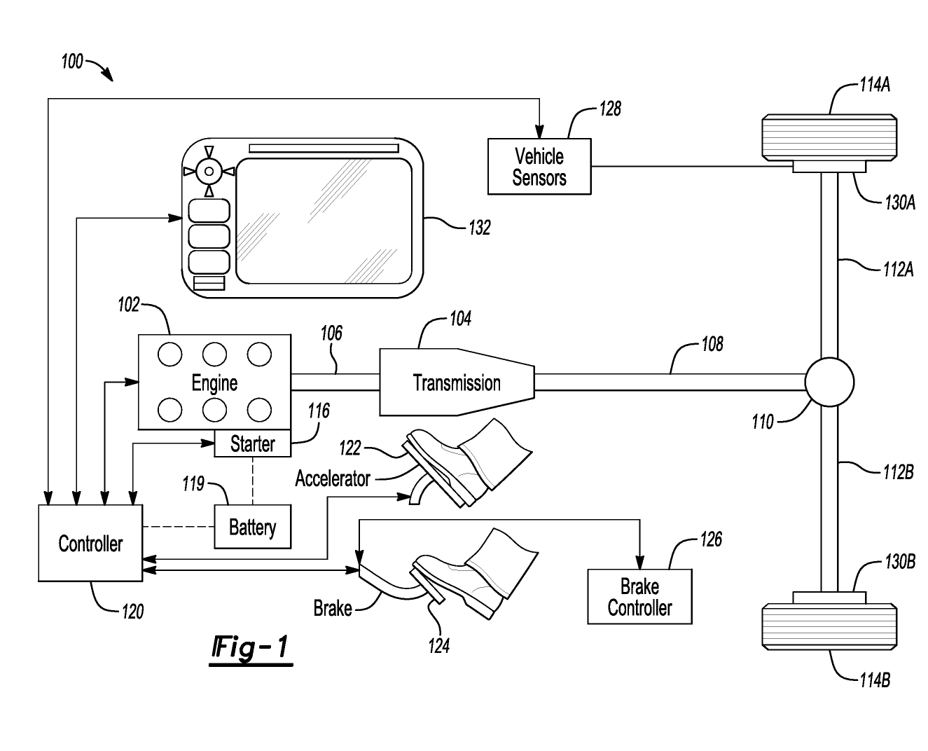

Referring to FIG. 1, a micro-hybrid vehicle 100 (also known as a start-stop vehicle) includes an engine 102 and a transmission 104. A crankshaft of the engine 102 is drivably connected to the transmission input shaft 106 in order to transmit power from the engine to the transmission. The transmission 104 includes an output shaft 108 that is drivably connected to a differential 110. The differential 110 selectively provides power to the driven wheels 114A and 114B via one or more axles—such as half shafts 112A and 112B. In some embodiments, the differential 110 is disposed within the transmission housing. The vehicle 100 also includes an engine-starter motor 116 that is configured to rotate the crankshaft to turn-over the engine 102 in response to an engine-start signal from the controller 120. The engine-starter motor 116 may be an enhanced starter motor that is specifically designed for the increased duty cycle associated with a micro-hybrid vehicle. The starter 116 is powered by a battery 119, which may be a 12-volt battery, 24-volt battery, 48-volt battery or other low voltage battery or high-voltage battery. A low voltage battery is a battery with a DC voltage less than 100 Volts, a high voltage battery is a battery with a DC voltage equal to or greater than 100 Volts. In some embodiments, the engine may include multiple starter motors. A first starter motor may engage a ring gear of the flywheel to turn the engine over. A second motor may connect to the crankshaft pulley by belt, chain, or other means known in the art. Specifically in the case of RSS, the vehicle may have a dual battery system, i.e., a 12-volt battery for cranking and a 12-volt battery to support electrical loads when the engine is off and vehicle is moving. The two batteries are typically isolated by a disconnect switch.

An accelerator pedal 122 provides operator input to control a speed of the vehicle 100. The pedal 122 may include a pedal-position sensor that provides a pedal-position signal to the controller 120, which provides control signals to the engine 102.

A brake pedal 124 provides operator input to control the brakes of the vehicle. The brake controller 126 receives operator input through a brake pedal 124, and controls a friction brake system including wheel brakes 130A and 130B, which is operable to apply a braking force to the vehicle wheels such as vehicle wheel 114A and vehicle wheel 114B. The pedal 124 may include a pedal-position sensor that provides a pedal-position signal to the controller 120. The vehicle may include an electric-parking brake that is in communication with the controller 120. The controller 120 is programmed to automatically engage the parking brake when desired.

The controller 120 may be a plurality of controllers that communicate via a serial bus (e.g., Controller Area Network (CAN), FlexRay, Ethernet, etc.) or via dedicated electrical conduits. The controller generally includes any number of microprocessors, microcontrollers, ASICs, ICs, volatile (e.g., RAM, DRAM, SRAM, etc.) and non-volatile memory (e.g., FLASH, ROM, EPROM, EEPROM, MRAM, etc.) and software code to co-act with one another to perform a series of operations. The controller may also include predetermined data, or “look up tables” that are based on calculations and test data, and are stored within the memory. The controller may communicate with other vehicle systems and controllers over one or more wired or wireless vehicle connections using common bus protocols (e.g., CAN, LIN, Ethernet, etc.). Used herein, a reference to “a controller” refers to one or more controllers.

As noted above, embodiments of the present invention include a control system for controlling a start-stop system for an engine in a vehicle, such as the engine 102 and the vehicle 100. Such a control system may be embodied by one or more controllers, such as the controller 120. One goal of a vehicle start-stop system is to automatically stop the engine under certain conditions, while restarting it automatically when conditions change. This provides greater fuel economy and reduced emissions.

In some start-stop systems, the engine may be automatically stopped (“auto stopped”) when all of a certain set of conditions are met. For example, if the gear lever is in DRIVE, the brake pedal is pressed, the accelerator pedal is released, and the vehicle speed is zero, the engine 102 may be automatically stopped. Another condition that may be included in this set of conditions is that none of the vehicle subsystems (e.g., air conditioning or power steering) require the engine to be running. In a start-stop system where all conditions are required to be met before the engine is auto stopped, not only will the start-stop system inhibit the engine from being automatically stopped if any of the conditions in the set are not met, but once having been auto stopped, the engine may be automatically restarted if any of the conditions change.

Continuing with the example from above, one of the common conditions to stopping an engine is a speed or velocity of the vehicle being zero. Often, an engine will not be stopped while the vehicle is in motion. In some systems, the vehicle velocity may be greater than zero, but less than a lower speed threshold such as 1.5 mph or 3.5 mph. Here, a rolling start-stop system allows the engine 102 to be auto-stopped if the speed of the vehicle is within a speed range. The speed range includes an upper threshold speed (V_{Threshold}) and a lower threshold speed. The lower threshold speed may be a speed at which the vehicle may be stopped using an emergency brake such as at 0 mph, 2 mph or 5 mph. At the lower threshold speed, the voltage level threshold of the starter battery 118 is selected to provide an amount of charge needed to operate electrical vehicle components powered by the battery 118. The upper threshold speed may be a speed, associated with a voltage of the starter battery 118 indicative of a state of charge at which the electrical vehicle components including electric power steering (EPS), electric power brakes, electric stability control (ESC), and other vehicle dynamic systems may be operated while the vehicle is in motion. Along with vehicle control systems are vehicle comfort systems such as seat heaters, an air conditioning system, and a window defroster, these systems may use considerable power and may be required to be accounted for in the battery voltage calculation.

Another vehicle characteristic to consider when calculating an engine shut off point is a capacity and pressure of a vacuum reservoir used to provide brake boost vacuum assistance. The upper threshold speed may be selected from a range of speeds such as 15 mph. to 60 mph. The ability of the vehicle to steer and stop is dependent upon many conditions of the vehicle including speed, weight, angle of inclination, brake conditions, road conditions, and tire conditions. As these conditions change, the ability of the vehicle to steer and stop also changes. For example, a vehicle traveling downhill is more difficult to stop than if the vehicle was traveling uphill. Therefore, a controller 120 may be configured to set a fixed lower threshold based on a lower speed to guard against a range of the conditions that affect a vehicle's stopping. Also, the controller 120 may be configured to set a fixed upper threshold based on an upper speed to guard against a range of the conditions that affect a vehicle's stopping. Alternatively, the controller 120 may be configured to dynamically change the lower threshold and upper thresholds based on the conditions of the vehicle at a point in time.

The controller 120 may also be configured to dynamically change the lower threshold and upper thresholds based on the conditions of the vehicle at a future point in time. For example, a navigation system or a human-machine interface (HMI) including a navigation system 132 may be coupled with the controller 120 such that a route may be provided to controller. The route may include a change in elevation along the route and adjust the upper and lower speed thresholds according to the changes in potential braking along the route. The route may also include changes in posted speeds that are indicative of locations at which brakes may be applied to reduce the speed, or an accelerator pedal may be used to increase the speed. The route may include locations at which a potential stopping point is, such as static locations and dynamic locations. A static location at which a potential stopping point is, includes a traffic light, a stop sign, a round-about, or a yield sign. A dynamic location at which a potential stopping point is along the route includes locations associated with traffic congestion, weather conditions, road construction, or accidents. The route displayed by the navigation system within the HMI 132 may be based on map data that has been preloaded in the memory of the HMI 132, or the HMI 132 may receive data streamed from a remote server. The data may be streamed wirelessly using cellular, Wi-Fi or other standard technology. Based on the route, changes in elevation, and potential stopping points along the route the controller 120 may adjust the voltage level of the starter battery 118 to maintain a state of charge of the starter battery 118. This adjustment reserves power for electrical accessories that are powered by the battery 118 including electric power steering (EPS), electric power brakes, electric stability control (ESC), and other vehicle dynamic systems.

There are conditions in which restarting may be undesirable, for example, if the operator intends to place a vehicle in PARK, and shut the engine Off, or if the operator intends to place the vehicle in NEUTRAL and remained stopped. Therefore, in at least some embodiments of the present disclosure, the controller 120 is configured to account for these different requirements. For example, when the engine 102 has been auto stopped with the vehicle in DRIVE, and the gear lever of the transmission 104 is shifted out of DRIVE, the controller 120 may be configured to automatically restart the engine 102 under at least one condition, and to inhibit automatic restarting the engine 102 under at least one other condition.

Additional conditions in which restarting may be undesirable, for example, if the operator is operating the vehicle in “stop and go” conditions. For example, if the vehicle is in heavy traffic or in a line, the vehicle may frequently go from rolling, to a complete stop, to take off again within a short period of time (one to two seconds). When the controller 120 initiates a stop event in response to certain conditions and then starts the engine, one “loop” has occurred. According to one embodiments of this disclosure, an operator may inhibit the stopping of the vehicle by inputting specifying the number of loops (e.g. 3 stop events within 60 seconds) that may occur within a period of time before stopping the vehicle again. The operator may input or alter the limit of loops specified by altering the condition within the HMI 132. In addition to altering the number of loops, the driver or operator may specify a distance or time the number of auto stops must occur to establish one loop.

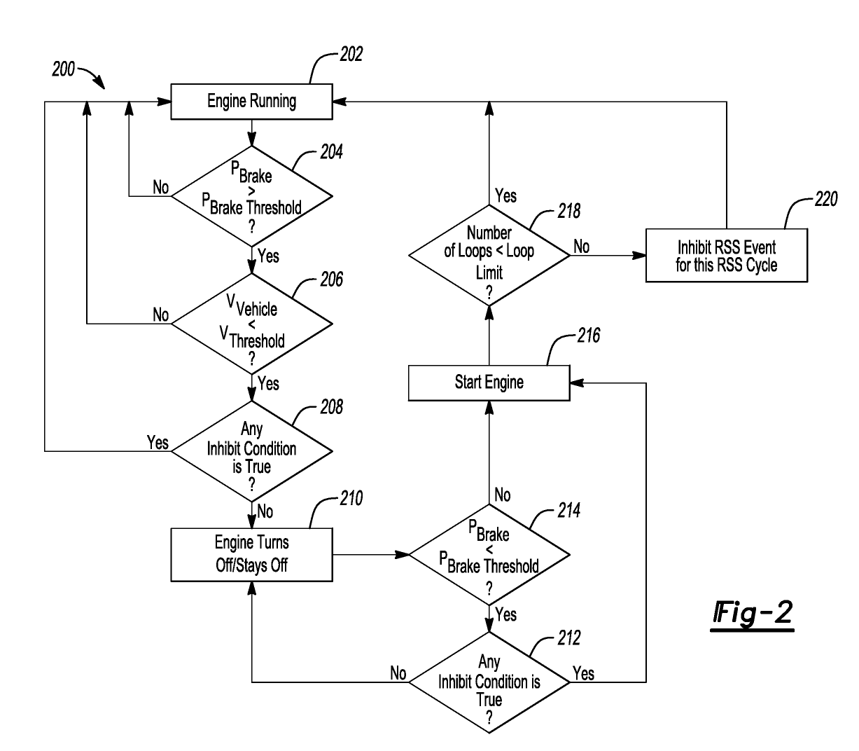

Control logic or functions performed by the controller 120 may be represented by flow charts or similar diagrams, such as the flow chart 200 in FIG. 2. FIG. 2 provides a representative control strategy and/or logic that may be implemented using one or more processing strategies such as polling, event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-controlled vehicle, engine, and/or powertrain controller, such as controller 120. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices that utilize electric, magnetic, and/or optical storage to keep executable instructions and associated calibration information, operating variables, and the like.

Referring to FIG. 2, a flow diagram illustrating an exemplary algorithm 200 for controlling a start-stop vehicle. In operation 202, the controller receives data from vehicle modules or sensors 128 indicating the condition of the vehicle. One of the conditions is that the engine is operating while the vehicle is in an ignition on condition and the vehicle is either stopped or in motion.

In operation 204, the controller branches based on brake pedal pressure. If the pressure of the brake (P_{Brake}) is greater than or equal to a threshold brake pressure (P_{Threshold}) the controller 120 will branch to operation 206. The brake pedal pressure includes depression of the brake pedal 124 by the operator. If the pressure of the brake (P_{Brake}) is not greater than or equal to a threshold brake pressure (P_{Threshold}) the controller branches back to operation 202.

In operation 206, the controller receives signals from vehicle sensors, such as 128, or vehicle modules, such as the brake controller 126, a powertrain control module (PCM), a transmission control module (TCM), or an electric stability control module (ESC). The controller branches based on vehicle speed or velocity. If the vehicle velocity (V_{Vehicle}) is less than a vehicle velocity threshold (V_{Threshold}) the controller will branch to operation 208.

In operation 208, if any auto-stop inhibitors are present, the controller will branch to operation 202. An auto-stop inhibitor is a condition in which the engine should not be auto-stopped, for example, a diagnostic mode may require the engine to continue to run and thus would be an auto-stop inhibitor. Other auto-stop inhibitors may include a temperature of the engine, a request for cabin heat, and a request for engine manifold vacuum. If there are no auto-stop inhibitors, the controller will branch to operation 210.

In operation 210, the controller engages auto stop based on other criteria such as input from vehicle sensors. The signals from the sensors may be indicative of a speed of the vehicle, a force applied to a brake pedal (or absence thereof), a force applied to an accelerator pedal (or absence thereof), an angle of inclination of the vehicle, a weight of the vehicle, a mode of operation, such as a diagnostic mode, use of vehicle accessories, such as seat heaters, or air conditioning, or other vehicle characteristic. After operation 210, the controller proceeds to operation 214.

In operation 214, the controller branches based on brake pedal pressure. If the pressure of the brake (P_{Brake}) is less than or equal to a threshold brake pressure (P_{Threshold}) the controller will branch to operation 212. The brake pedal pressure includes depression of the brake pedal by the operator. If the pressure of the brake (P_{Brake}) is greater than or equal to a threshold brake pressure (P_{Threshold}) the controller branches back to operation 216. In operation 216, the controller will auto-start the engine and one “loop” is completed.

In operation 218, the controller branches based on the number of loops or the number of starts within a specified time period. If the number of loops is below a loop limit, the controller branches to 202 and the engine remains running. If the number of loops is above the loop limit the controller branches to 220. In operation 220, the controller will inhibit the start-stop feature, inhibiting the controller from auto stopping the engine.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as Read Only Memory (ROM) devices and information alterably stored on writeable storage media such as floppy disks, magnetic tapes, Compact Discs (CDs), Random Access Memory (RAM) devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A vehicle comprising:
an engine;
a human-machine interface (HMI) configured to allow a user to specify a loop threshold value; and
a controller configured to, in response to the vehicle equaling or exceeding the loop threshold value, inhibit further auto stops of the engine wherein the loop threshold value equals a number of auto stops of the engine that occur within a first predefined time period.

2. The vehicle of claim 1, wherein the inhibiting is for a second predefined time period.

3. The vehicle of claim 2, wherein the second predefined time period is user defined.

4. The vehicle of claim 1, wherein the first predefined time period is user defined.

5. The vehicle of claim 1, wherein the loop threshold value equals a number of auto stops of the engine that occur within a predefined distance travelled by the vehicle.

6. The vehicle of claim 5, wherein the controller is further configured to inhibit further auto stops of the engine for a second predefined distance in response to altering a condition within the HMI.

7. The vehicle of claim 6, wherein the second predefined distance is user defined in response to altering a condition within the HMI.

8. The vehicle of claim 7, wherein the first predefined distance is user defined in response to altering a condition within the HMI.

9. The vehicle of claim 1, wherein the HMI is adapted to prompt a user to provide feedback regarding whether further auto stops of the engine should be inhibited, and in response to altering a condition of the HMI, and provide a signal to the controller to inhibit further auto stops of the engine.

10. A vehicle comprising:
an engine;
a controller configured to auto stop the engine in response to a speed of the engine being less than a threshold; and
a human-machine interface (HMI) configured to prompt a user to provide feedback regarding whether further auto stops should be inhibited, and in response to the user altering a condition of the HMI, to provide a signal to the controller to inhibit further auto stops.

11. The vehicle of claim 10, wherein the controller is further configured to, in response to a number of auto stops that occur within a first predefined time period exceeding a user defined threshold value, inhibit further auto stops.

12. The vehicle of claim 11, wherein the inhibiting is for a second predefined time period.

13. The vehicle of claim 11, wherein the controller is further configured to, in response to a number of auto stops that occur within a first predefined distance travelled by the vehicle exceeding a second user predefined threshold value, inhibit further auto stops.

14. The vehicle of claim 13, wherein the inhibiting further auto stops is for a second predefined distance.

15. A vehicle comprising:
an engine;
a controller configured to, in response to a number of auto stops of the engine that occur within a first predefined distance travelled by the vehicle exceeding the loop threshold value, inhibit further auto stops of the engine; and
a human-machine interface (HMI) configured to prompt a user to provide feedback regarding whether further auto stops should be inhibited, and in response to the user altering a condition of the HMI, to provide a signal to the controller to inhibit further auto stops.

16. The vehicle of claim 15, wherein the first predefined distance is user defined.

17. The vehicle of claim 15, wherein the inhibiting is for a second predefined distance.

18. (canceled)

19. The vehicle of claim 15, wherein the controller is further configured to auto stop the engine in response to a brake pressure exceeding a pressure threshold value.

20. The vehicle of claim 15, wherein the controller is further configured to auto stop the engine in response to a speed of the engine being less than a threshold.
